(19) United States
(12) Patent Application Publication
(10) Pub. No.: US 2022/0196134 A1
(43) Pub. Date: Jun. 23, 2022

(54) TRANSAXLE FOR ELECTRIC VEHICLE

(71) Applicant: TOYOTA JIDOSHA KABUSHIKI KAISHA, Toyota-shi (JP)

(72) Inventors: Masashi IKEMURA, Toyota-shi (JP); Yukihiko IDESHIO, Nisshin-shi (JP); Tetsuya YAMAGUCHI, Anjo-shi (JP)

(73) Assignee: TOYOTA JIDOSHA KABUSHIKI KAISHA, Toyota-shi (JP)

(21) Appl. No.: 17/548,616

(22) Filed: Dec. 13, 2021

(30) Foreign Application Priority Data
Dec. 17, 2020 (JP) 2020-209509

(51) Int. Cl. F16H 57/00; B60K 1/02; F16H 1/46; B60K 17/04

(52) U.S. Cl. CPC F16H 57/0006; B60K 1/02; F16H 2057/02034; B60K 17/04; F16H 2057/0012; F16H 1/46

(57) ABSTRACT

A transaxle includes a first motor generator, a second motor generator, a first planetary gear train, a second planetary gear train, a ring gear shaft, and a case. The first planetary gear train includes a first sun gear, a first carrier, and a first ring gear. The second planetary gear train includes a second sun gear, a second carrier, and a second ring gear. The first sun gear is coupled to the first motor generator, and the first ring gear is coupled to the ring gear shaft. The second sun gear is coupled to the second motor generator, and the second ring gear is coupled to the ring gear shaft. The first carrier and the second carrier are not rotatable relative to the case.

### CROSS-REFERENCE TO RELATED APPLICATION

This application claims priority to Japanese Patent Application No. 2020-209509 filed on Dec. 17, 2020, incorporated herein by reference in its entirety.

### BACKGROUND

### 1. Technical Field

The present disclosure relates to a transaxle for an electric vehicle.

### 2. Description of Related Art

Japanese Unexamined Patent Application Publication No. 2010-252584 (JP 2010-252584 A) describes a vehicle including an internal combustion engine as a drive source. JP 2010-252584 A describes a technique for manufacturing a so-called electric vehicle by replacing an internal combustion engine of a vehicle with a motor generator serving as a drive source.

### SUMMARY

There is known a so-called hybrid vehicle that is a vehicle including an internal combustion engine and a motor generator as drive sources. JP 2010-252584 A only describes a technique for converting a vehicle including only an internal combustion engine as a drive source into an electric vehicle. Therefore, in converting a hybrid vehicle into an electric vehicle, there is room for further studies in terms of what structure that is suitable as a transaxle for an electric vehicle.

A transaxle for an electric vehicle includes a first motor generator serving as a drive source, a second motor generator serving as a drive source, a first planetary gear train coupled to the first motor generator, a second planetary gear train coupled to the second motor generator, an output shaft coupled to the first planetary gear train and the second planetary gear train, a driving force of each of the first motor generator and the second motor generator being transmitted to the output shaft, and a case accommodating the first planetary gear train and the second planetary gear train. The first planetary gear train includes a first sun gear, a first ring gear located coaxially with the first sun gear, first pinion gears in mesh with the first sun gear and the first ring gear, and a first carrier supporting the first pinion gears such that the first pinion gears are rotatable. The second planetary gear train includes a second sun gear, a second ring gear located coaxially with the second sun gear, second pinion gears in mesh with the second sun gear and the second ring gear, and a second carrier supporting the second pinion gears such that the second pinion gears are rotatable. The first sun gear is coupled to the first motor generator, and the first ring gear is coupled to the output shaft. The second sun gear is coupled to the second motor generator, and the second ring gear is coupled to the output shaft. The first carrier and the second carrier are not rotatable relative to the case.

The thus configured transaxle for an electric vehicle can be manufactured by using a transaxle for a hybrid vehicle, including a first motor generator, a second motor generator, a first planetary gear train, and a second planetary gear train, as a base. Specifically, when a carrier coupled to an internal combustion engine is separated from the internal combustion engine and is fixed so as to be not rotatable relative to the case, the transaxle capable of transmitting a driving force of each of the first motor generator and the second motor generator to the output shaft can be manufactured. Therefore, the above-described transaxle has a structure that can be manufactured by effectively using both the first motor generator and the second motor generator of the hybrid vehicle.

In the above configuration, the transaxle may further include a first shaft connected to the first carrier, and a damper fixed to the first shaft. The case may accommodate the damper. The first carrier may be fixed to the case via the first shaft and the damper.

With the above configuration, for example, a first shaft and a damper that have been originally provided in a transaxle of a hybrid vehicle can be used as a part of members for fixing the first carrier to the case such that the first carrier is not rotatable relative to the case.

In the above configuration, the transaxle may further include a flywheel fixed to the damper. The first carrier may be fixed to the case via the first shaft, the damper, and the flywheel.

With the above configuration, for example, a flywheel that has been originally provided in a transaxle of a hybrid vehicle can be used as a part of members for fixing the first carrier to the case such that the first carrier is not rotatable relative to the case.

In the above configuration, the transaxle may further include a fixing member fixed to the case. When, of directions along a central axis of the first carrier, a direction toward the first motor generator when viewed from the second motor generator is defined as a first direction, the case may have a bolt hole at an end in the first direction. The fixing member may be fixed to the case by a bolt inserted through the bolt hole. The first carrier may be fixed to the case via the fixing member.

With the above configuration, for example, the bolt hole for fixing the case of the transaxle to another member, such as an internal combustion engine, can be used as a part of members for fixing the first carrier to the case such that the first carrier is not rotatable relative to the case.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a vehicle; and

FIG. 2 is a cross-sectional view showing a configuration around a fixing member in a transaxle.

### DETAILED DESCRIPTION OF EMBODIMENTS

### Mechanical Configuration of Vehicle

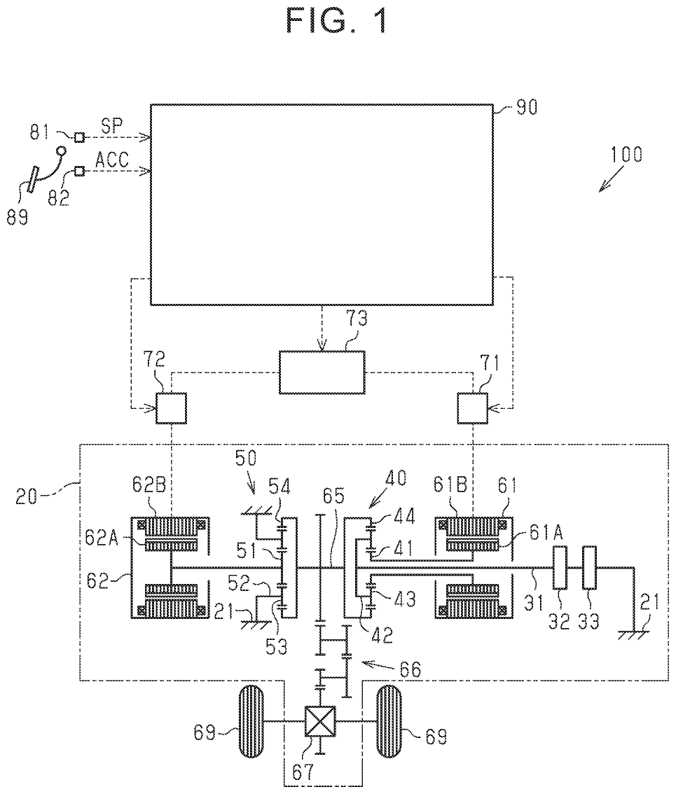

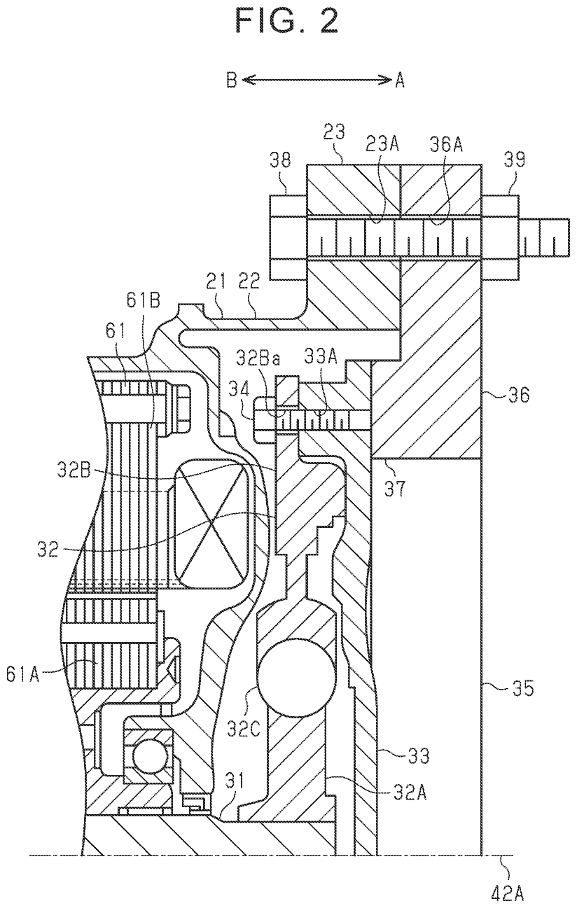

Hereinafter, an embodiment of the present disclosure will be described with reference to FIG. 1 and FIG. 2. Initially, the schematic configuration of a vehicle 100 to which a transaxle 20 for an electric vehicle according to the present disclosure is applied will be described. The vehicle 100 is an electric vehicle converted from a hybrid vehicle.

As shown in FIG. 1, the vehicle 100 includes the transaxle 20 and a plurality of drive wheels 69 as a path through which power is transmitted. The transaxle 20 includes a first motor generator 61 serving as a drive source, and a second motor generator 62 serving as a drive source. The transaxle 20 includes a case 21, a first planetary gear train 40, a second planetary gear train 50, a ring gear shaft 65, a speed reduction mechanism 66, and a differential 67. The transaxle 20 is converted from the one that is a so-called hybrid transaxle in the hybrid vehicle.

The case 21 accommodates the first motor generator 61, the second motor generator 62, the first planetary gear train 40, the second planetary gear train 50, the ring gear shaft 65, the speed reduction mechanism 66, and the differential 67.

The first planetary gear train 40 includes a first sun gear 41, a first carrier 42, and a plurality of first pinion gears 43, and a first ring gear 44. The first sun gear 41 that is an external gear and the first ring gear 44 that is an internal gear are located coaxially. The first sun gear 41 is coupled to the first ring gear 44 via the first pinion gears 43. The first pinion gears 43 are in mesh with the first sun gear 41 and the first ring gear 44. The first carrier 42 supports the first pinion gears 43 such that the first pinion gears 43 are rotatable. The first carrier 42 is fixed to the case 21. In other words, the first carrier 42 is not rotatable relative to the case 21. A configuration to fix the first carrier 42 to the case 21 will be described later. Since the first carrier 42 is not rotatable relative to the case 21, the first pinion gears 43 are not revolvable. The first sun gear 41 is coupled to the first motor generator 61.

The first motor generator 61 includes a rotor 61A and a stator 61B. The rotor 61A is rotatable relative to the stator 61B. The rotor 61A is coupled to the first sun gear 41. The rotor 61A rotates integrally with the first sun gear 41.

The first ring gear 44 is coupled to the ring gear shaft 65. The ring gear shaft 65 rotates integrally with the first ring gear 44. The ring gear shaft 65 is coupled to the speed reduction mechanism 66. The speed reduction mechanism 66 is, for example, a speed reduction gear mechanism. The speed reduction mechanism 66 is coupled to the drive wheels 69 via the differential 67. The differential 67 allows a rotation speed difference between the right and left drive wheels 69.

The ring gear shaft 65 is coupled to the second planetary gear train 50.

The second planetary gear train 50 includes a second sun gear 51, a second carrier 52, a plurality of second pinion gears 53, and a second ring gear 54. The second sun gear 51 that is an external gear and the second ring gear 54 that is an internal gear are located coaxially. The second sun gear 51 is coupled to the second ring gear 54 via the second pinion gears 53. The second pinion gears 53 are in mesh with the second sun gear 51 and the second ring gear 54. The second carrier 52 supports the second pinion gears 53 such that the second pinion gears 53 are rotatable. The second carrier 52 is fixed to the case 21. In other words, the second carrier 52 is not rotatable relative to the case 21. Since the second carrier 52 is not rotatable relative to the case 21, the second pinion gears 53 are not revolvable. The second ring gear 54 is coupled to the ring gear shaft 65. The second ring gear 54 rotates integrally with the ring gear shaft 65. The second sun gear 51 is coupled to the second motor generator 62.

The second motor generator 62 includes a rotor 62A and a stator 62B. The rotor 62A is rotatable relative to the stator 62B. The rotor 62A is coupled to the second sun gear 51. The rotor 62A rotates integrally with the second sun gear 51.

The second motor generator 62 is located across the first planetary gear train 40 and the second planetary gear train 50 from the first motor generator 61. The first carrier 42, the second carrier 52, the rotor 61A, and the rotor 62A are located coaxially.

The second motor generator 62 is capable of functioning as a generator at the time of decelerating the vehicle 100 to cause the vehicle 100 to generate regenerative braking force according to the amount of electric power generated by the second motor generator 62. Similarly, the first motor generator 61 is capable of functioning as a generator at the time of decelerating the vehicle 100 to cause the vehicle 100 to generate regenerative braking force according to the amount of electric power generated by the first motor generator 61 can be generated.

On the other hand, when the second motor generator 62 functions as an electric motor, the rotor 62A rotates with respect to the stator 62B. The torque of the second motor generator 62 is input to the drive wheels 69 via the second planetary gear train 50, the ring gear shaft 65, the speed reduction mechanism 66, and the differential 67. Then, the drive wheels 69 are rotated by the torque of the second motor generator 62. Similarly, when the first motor generator 61 functions as an electric motor, the torque of the first motor generator 61 is input to the drive wheels 69 via the first planetary gear train 40, the ring gear shaft 65, the speed reduction mechanism 66, and the differential 67.

Then, the drive wheels 69 are rotated by the torque of the first motor generator 61. The driving force of each of the first motor generator 61 and the second motor generator 62 is transmitted to the drive wheels 69 via the ring gear shaft 65. In the present embodiment, the ring gear shaft 65 is an example of an output shaft. Electrical Configuration of Vehicle

Next, the electrical configuration of the vehicle 100 will be described.

As shown in FIG. 1, the vehicle 100 includes a first inverter 71, a second inverter 72, and a battery 73 as devices for exchanging electric power. The first inverter 71 adjusts the amount of electric power exchanged between the first motor generator 61 and the battery 73. The second inverter 72 adjusts the amount of electric power exchanged between the second motor generator 62 and the battery 73.

The vehicle 100 includes a vehicle speed sensor 81, an accelerator operation amount sensor 82, and an accelerator pedal 89. The vehicle speed sensor 81 detects a vehicle speed SP that is the speed of the vehicle 100. The accelerator operation amount sensor 82 detects an accelerator operation amount ACC that is an operation amount of the accelerator pedal 89 operated by a driver.

The vehicle 100 includes a control apparatus 90. A signal indicating a vehicle speed SP is input from the vehicle speed sensor 81 to the control apparatus 90. A signal indicating an accelerator operation amount ACC is input from the accelerator operation amount sensor 82 to the control apparatus 90.

The control apparatus 90 prestores various programs. The control apparatus 90 controls the first motor generator 61, the second motor generator 62, and the like by running various programs. Specifically, the control apparatus 90 calculates a vehicle required output based on an accelerator operation amount ACC and a vehicle speed SP. A vehicle required output is a required value of output needed for the vehicle 100 to run. The control apparatus 90 determines a torque distribution between the first motor generator 61 and the second motor generator 62 based on a vehicle required output. The control apparatus 90 controls power running and regeneration of each of the first motor generator 61 and the second motor generator 62 based on a torque distribution between the first motor generator 61 and the second motor generator 62.

The control apparatus 90 can be configured as circuitry including one or more processors that execute various processes in accordance with a computer program (software). The control apparatus 90 may be configured as one or more dedicated hardware circuits, such as an application-specific integrated circuit (ASIC), that execute at least part of the various processes, or circuitry including a combination of them. Each processor includes a CPU, and a memory, such as a RAM and a ROM. The memory stores a program code or an instruction configured to cause the CPU to execute a process. The memory, that is, a computer-readable medium, includes any medium accessible by a general-purpose or dedicated computer.

### Peripheral Configuration of First Carrier

Next, the peripheral configuration of the first carrier 42 will be described. Hereinafter, of directions along a central axis 42A of the first carrier 42, a direction toward the first motor generator 61, that is the right-hand side in FIG. 2, when viewed from the second motor generator 62 is referred to as first direction A. A direction opposite the first direction A, that is, the left-hand side in FIG. 2, is referred to as second direction B.

As shown in FIG. 2, the case 21 includes a case body 22 and a flange 23. The case body 22 has a substantially cylindrical shape. In other words, the case body 22 is open at an end in the first direction A. The opening of the case body 22 has a substantially circular shape of which the center axis coincides with the central axis 42A. The flange 23 radially projects from the outer periphery of the case body 22. The flange 23 extends all around the outer periphery of the case body 22 and has a substantially annular shape. The flange 23 is located at the end, in the first direction A, of the case body 22. The flange 23 has a plurality of bolt holes 23A. The bolt holes 23A extend through the flange 23 in a direction along the central axis 42A. Each of the bolt holes 23A is spaced apart from the other bolt hole 23A. The bolt holes 23A have been used as mounting holes for fixing the case 21 to an internal combustion engine in the hybrid vehicle.

As shown in FIG. 1 and FIG. 2, the transaxle 20 includes a first shaft 31, a damper 32, a flywheel 33, a plurality of bolts 34, a fixing member 35, a plurality of bolts 38, and a plurality of nuts 39 as components for fixing the first carrier 42 to the case 21. As shown in FIG. 2, the case body 22 accommodates the first shaft 31, the damper 32, and the flywheel 33.

As shown in FIG. 1, the first shaft 31 is connected to the first carrier 42.

As shown in FIG. 2, the first shaft 31 has a substantially rod shape. The first shaft 31 is located coaxially with the first carrier 42 not shown in FIG. 2. In other words, the central axis of the first shaft 31 coincides with the central axis 42A. An end, in the first direction A, of the first shaft 31 is located near the end, in the first direction A, of the case body 22. The first shaft 31 has been functioning as an input shaft that inputs the driving force of the internal combustion engine to the first carrier 42 in the hybrid vehicle.

As shown in FIG. 2, the damper 32 is fixed to the first shaft 31. The damper 32 is located at the end, in the first direction A, of the first shaft 31. The damper 32 has a disc shape as a whole. The damper 32 includes a radially inner-side inner portion 32A, a radially outer-side outer portion 32B, and a spring 32C interposed between the inner portion 32A and the outer portion 32B. In other words, the damper 32 has been functioning to absorb torque fluctuations of the internal combustion engine and to transmit the driving force of the internal combustion engine to the first shaft 31 in the hybrid vehicle. In the present embodiment, the damper 32 and the first shaft 31 are fixed by so-called spline coupling, that is, coupling using a plurality of protrusions and a plurality of recesses formed in the damper 32 and the first shaft 31. The outer portion 32B has a plurality of through-holes 32Ba extending through in the direction along the central axis 42A. The through-holes 32Ba are located at the radially outer end of the outer portion 32B.

The flywheel 33 is located in the first direction A with respect to the damper 32 when viewed from the damper 32. The flywheel 33 has a substantially disc shape. The outside diameter of the flywheel 33 is substantially the same as the outside diameter of the damper 32. The flywheel 33 has a plurality of threaded holes 33A extending through in the direction along the central axis 42A. The locations of the threaded holes 33A of the flywheel 33 correspond to the locations of the through-holes 32Ba of the outer portion 32B. In other words, when viewed in the direction along the central axis 42A, the locations of the threaded holes 33A of the flywheel 33 coincide with the locations of the through-holes 32Ba of the outer portion 32B. The bolts 34 pass through the through-holes 32Ba and the threaded holes 33A. In other words, in the present embodiment, the flywheel 33 and the damper 32 are fixed by the bolts 34. The flywheel 33 has been functioning to stabilize the rotation speed of a crankshaft of the internal combustion engine in the hybrid vehicle.

The fixing member 35 is located in the first direction A with respect to the flywheel 33 when viewed from the flywheel 33. The fixing member 35 includes an annular plate 36 and a projecting portion 37. The annular plate 36 has a substantially annular shape. The outside diameter of the annular plate 36 is substantially the same as the outside diameter of the flange 23. The inside diameter of the annular plate 36 is less than the outside diameter of the flywheel 33. The central axis of the annular plate 36 substantially coincides with the central axis 42A of the first carrier 42. The projecting portion 37 protrudes from an end face, in the second direction B, of the annular plate 36. The projecting portion 37 is located at the radially inner end of the annular plate 36. The projecting portion 37 extends all around the annular plate 36 and has a substantially annular shape. A projected distal end face of the projecting portion 37 is in contact with the flywheel 33. In the present embodiment, the projecting portion 37 and the flywheel 33 are fixed by welding.

The annular plate 36 has a plurality of insertion holes 36A. The insertion holes 36A extend through the annular plate 36 in the direction along the central axis 42A. The locations of the insertion holes 36A correspond to the locations of the bolt holes 23A.

In other words, when viewed in the direction along the central axis 42A, the locations of the insertion holes 36A coincide with the locations of the bolt holes 23A. The annular plate 36 is fixed to the flange 23 of the case 21 by the bolts 38 inserted through the insertion holes 36A and the bolt holes 23A, and the nuts 39 fixed to the bolts 38. Therefore, the first carrier 42 is fixed to the case 21 via the first shaft 31, the damper 32, the flywheel 33, and the fixing member 35.

### Operation of Present Embodiment

In the hybrid vehicle before being converted into the vehicle 100, the first carrier 42 is coupled to the crankshaft of the internal combustion engine via the first shaft 31, the damper 32, and the flywheel 33. In converting the hybrid vehicle into the vehicle 100, when the internal combustion engine is removed and the first carrier 42 is separated from the crankshaft of the internal combustion engine, the first carrier 42 freely rotates. When the first carrier 42 is freely rotated in this way, the driving force of the first motor generator 61 is consumed as the rotating force of the first carrier 42, and the driving force of the first motor generator 61 is not appropriately transmitted to the ring gear shaft 65.

As a result, driving force transmitted from the first motor generator 61 to the drive wheels 69 via the ring gear shaft 65 can reduce or driving force cannot be transmitted.

In contrast, in the transaxle 20, the first carrier 42 is not rotatable relative to the case 21. Therefore, there is no case where the driving force of the first motor generator 61 is not transmitted to the ring gear shaft 65 due to rotation of the first carrier 42 relative to the case 21. As a result, the driving force of each of the first motor generator 61 and the second motor generator 62 is transmitted to the drive wheels 69.

When the driving force of the first motor generator 61 acts on the first carrier 42, the first carrier 42 can slightly vibrate due to the configuration that the first carrier 42 is fixed to the case 21 via the damper 32. However, in this case as well, the rotation angle of the first carrier 42 is about several angles to about several tens of angles, and the first carrier 42 does not rotate 360 degrees about the central axis 42A. Therefore, the first carrier 42 is not rotatable relative to the case 21.

### Advantageous Effects of Present Embodiment

(1) The transaxle 20 can be manufactured by using a transaxle of a hybrid vehicle as a base and making the first carrier 42 not rotatable relative to the case 21. Therefore, the transaxle 20 has a structure that can be manufactured by effectively using both the first motor generator 61 and the second motor generator 62 in the transaxle of the hybrid vehicle.

(2) The first carrier 42 is fixed to the case 21 via the first shaft 31, the damper 32, and the flywheel 33. With this configuration, the first shaft 31, the damper 32, and the flywheel 33, which have been originally provided in the transaxle of the hybrid vehicle, can be used as a part of members for fixing the first carrier 42 to the case 21 such that the first carrier 42 is not rotatable relative to the case 21. With this configuration, in fixing the first carrier 42 to the case 21 such that the first carrier 42 is not rotatable relative to the case 21, the inside diameter of the annular plate 36 in the fixing member 35 is increased, so a radial dimension that is a difference between the inside diameter and the outside diameter of the annular plate 36 is reduced. As a result of the reduction of the radial dimension of the annular plate 36, reduction of cost to manufacture the fixing member 35 and reduction of the weight of the fixing member 35 are expected.

(3) The annular plate 36 in the fixing member 35 is fixed to the case 21 by the bolts 38 inserted through the insertion holes 36A and the bolt holes 23A, and the nuts 39 fixed to the bolts 38. The projecting portion 37 in the fixing member 35 is fixed to the flywheel 33. In other words, the first carrier 42 is fixed to the case 21 via the fixing member 35. With this configuration, the bolt holes 23A that have been used to fix the case 21 of the transaxle 20 to the internal combustion engine in the hybrid vehicle can be used as a part of members for fixing the first carrier 42 to the case 21 such that the first carrier 42 is not rotatable relative to the case 21. With this configuration, in fixing the first carrier 42 to the case 21 such that the first carrier 42 is not rotatable relative to the case 21, it is not required to change the shape of the case 21 or perform additional machining of the case 21.

The present embodiment may be modified as follows. The present embodiment and the following modifications may be implemented in combination with each other without any technical contradiction. In the above embodiment, a fixing method for fixing the fixing member 35 to the case 21 may be changed. For example, the bolts 38 do not necessarily need to be used, and the annular plate 36 in the fixing member 35 may be fixed to the flange 23 of the case 21 by welding.

In the above embodiment, fixing points between the case 21 and the fixing member 35 may be changed. For example, the fixing member 35 does not need to be fixed to the flange 23 of the case 21, and the annular plate 36 of the fixing member 35 may be fixed to the case body 22 of the case 21.

In the above embodiment, in making the first carrier 42 not rotatable relative to the case 21, the fixing member 35 does not need to be fixed to the case 21. For example, the fixing member 35 may be fixed to a frame member, such as a frame, in the vehicle 100. With this configuration as well, as long as the case 21 is fixed to the frame member, such as a frame, the first carrier 42 is not rotatable relative to the case 21 as a result.

In the above embodiment, in making the first carrier 42 not rotatable relative to the case 21, members interposed between the first carrier 42 and the case 21 may be changed. For example, a part of the members interposed between the first carrier 42 and the case 21, that is, the first shaft 31, the damper 32, the flywheel 33, and the fixing member 35, may be omitted or all of them may be omitted.

In the above embodiment, parts of the transaxle 20 may be changed. For example, the transaxle 20 may additionally include another gear mechanism.

What is claimed is:

1. A transaxle for an electric vehicle, the transaxle comprising:
a first motor generator serving as a drive source;
a second motor generator serving as a drive source;
a first planetary gear train coupled to the first motor generator;
a second planetary gear train coupled to the second motor generator;
an output shaft coupled to the first planetary gear train and the second planetary gear train, a driving force of each of the first motor generator and the second motor generator being transmitted to the output shaft; and
a case accommodating the first planetary gear train and the second planetary gear train, wherein:
the first planetary gear train includes a first sun gear, a first ring gear located coaxially with the first sun gear, first pinion gears in mesh with the first sun gear and the first ring gear, and a first carrier supporting the first pinion gears such that the first pinion gears are rotatable;
the second planetary gear train includes a second sun gear, a second ring gear located coaxially with the second sun gear, second pinion gears in mesh with the second sun gear and the second ring gear, and a second carrier supporting the second pinion gears such that second pinion gears are rotatable;
the first sun gear is coupled to the first motor generator, and the first ring gear is coupled to the output shaft;
the second sun gear is coupled to the second motor generator, and the second ring gear is coupled to the output shaft; and
the first carrier and the second carrier are not rotatable relative to the case.

2. The transaxle according to claim 1, further comprising:
a first shaft connected to the first carrier; and
a damper fixed to the first shaft, wherein:
the case accommodates the damper; and
the first carrier is fixed to the case via the first shaft and the damper.

3. The transaxle according to claim 2, further comprising a flywheel fixed to the damper, wherein the first carrier is fixed to the case via the first shaft, the damper, and the flywheel.

4. The transaxle according to claim 1, further comprising a fixing member fixed to the case, wherein:
when, of directions along a central axis of the first carrier, a direction toward the first motor generator when viewed from the second motor generator is defined as a first direction, the case has a bolt hole at an end in the first direction;
the fixing member is fixed to the case by a bolt inserted through the bolt hole; and
the first carrier is fixed to the case via the fixing member.
